(19) United States
(12) Patent Application Publication
(10) Pub. No.: US 2026/0229431 A1
(43) Pub. Date: Aug. 6, 2026

(54) VACUUM CIRCUIT BREAKER

(71) Applicant: HD HYUNDAI ELECTRIC CO., LTD., Seongnam-si (KR)

(72) Inventor: Keon-Woo KIM, Seongnam-si (KR)

(21) Appl. No.: 19/150,896

(22) PCT Filed: Aug. 22, 2023
(86) PCT No.: PCT/KR2023/012405

§ 371 Date: Jul. 24, 2025

(30) Foreign Application Priority Data
Mar. 14, 2023 (KR) 10-2023-0032973

(51) Int. Cl. H01H 33/666

(52) U.S. Cl. CPC H01H 33/666

(57) ABSTRACT

Provided is a vacuum circuit breaker that can increase structural stability and reduce required space by reducing the distance from a pressure vessel to a driving unit. A vacuum circuit breaker includes: a pressure vessel that is filled with insulating gas at a predetermined pressure; a vacuum interrupter disposed inside the pressure vessel and having a fixed electrode and a movable electrode within a vacuum tube in a vacuum state; and a spring module that has one side connected to an end of the movable electrode through an insulating link, moves through the pressure vessel while maintaining airtightness to transmit driving force of a driving unit to the movable electrode, and is equipped with a spring that applies contact pressure to the movable electrode when closing the contacts.

### TECHNICAL FIELD

The present disclosure relates to a vacuum circuit breaker capable of reducing a distance from a pressure vessel to a driving unit to increase structural stability and reduce a required space.

### BACKGROUND ART

In general, a vacuum circuit breaker may be a type of circuit breaker installed in a high-voltage power system to protect the power system by cutting off a circuit when a dangerous situation such as short-circuit, overcurrent, or the like occurs, and may be designed by utilizing excellent insulation performance and arc-extinguishing power in a vacuum state.

A core component of such a vacuum circuit breaker may be a vacuum interrupter. The vacuum interrupter may include a fixed electrode and a movable electrode that may be contacted or separated from the fixed electrode in a sealed vacuum tube, and may perform functions of electrifying and cutting off the circuit by contacting and separating the fixed electrode and the movable electrode.

An interior of the vacuum interrupter may be in a vacuum state, and an exterior thereof may be surrounded by a pressure vessel, to which gas pressure may be applied. Accordingly, a movable rod may be interposed between a driving unit and the movable electrode in order to transmit driving force of the driving unit located outside the pressure vessel to the movable electrode. In addition, a contact pressure spring for transmitting contact pressure during input of the movable electrode may be disposed between the driving unit and the movable rod.

In this case, since the contact pressure spring may be installed in an end portion of the movable rod outside the pressure vessel, the driving unit should be disposed considerably farther away from or higher than the pressure vessel, which entirely causes structural instability of a device and increases unnecessary space.

### DISCLOSURE OF INVENTION

### Technical Problem

The purpose of the present disclosure is to provide a vacuum circuit breaker capable of reducing a distance from a pressure vessel to a driving unit to increase structural stability and reduce a required space.

### Solution to Problem

A vacuum circuit breaker according to an embodiment of the present disclosure may include a pressure vessel filled with an insulating gas of a predetermined pressure; a vacuum interrupter disposed in an internal space of the pressure vessel, and having a fixed electrode and a movable electrode in a vacuum tube having a vacuum state; and a spring module having one side connected to an end portion of the movable electrode via an insulating link, and having a spring applying contact pressure to the movable electrode when the movable electrode is input. The spring module may penetrate through and moving in the pressure vessel while maintaining airtightness to transmit driving force of a driving unit to the movable electrode.

The spring module may include a case having one side closed and the other side opened; a guide receiving the driving force of the driving unit to reciprocate along an inner circumferential surface of the case in an internal space of the case; the spring having one end supported by an inner surface of the closed one side of the case and the other end supported by the guide; and a stopper mounted on the opened other side of the case to restrict movement of the guide.

### Advantageous Effects of Invention

According to an embodiment of the present disclosure, stroke of a spring module may be confirmed and adjusted outside a pressure vessel, and a distance from the pressure vessel to a driving unit may be reduced, to obtain effects of securing stability of an operation and structure of a vacuum circuit breaker.

In addition, according to an embodiment of the present disclosure, when a driving unit is disposed above a pressure vessel, a mounting height of the driving unit may be lowered to eliminate a required space to be unnecessarily generated.

### BRIEF DESCRIPTION OF DRAWINGS

FIG. 1 is a view illustrating a vacuum circuit breaker according to an embodiment of the present disclosure.

FIG. 2 is an enlarged cross-sectional view illustrating a spring module.

### BEST MODE FOR INVENTION

Hereinafter, the present disclosure will be described in detail through illustrative drawings. When adding reference symbols to components in each of the drawings, it should be noted that the same components are given the same symbols as much as possible even if they are illustrated in different drawings.

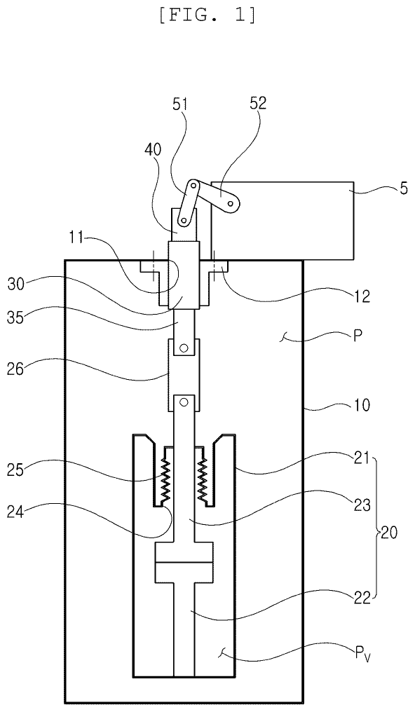

FIG. 1 is a view illustrating a vacuum circuit breaker according to an embodiment of the present disclosure.

A vacuum circuit breaker according to an embodiment of the present disclosure may include a pressure vessel 10, a vacuum interrupter 20, and a spring module 30.

The pressure vessel 10 may be a sealed vessel housing the vacuum interrupter 20 of the vacuum circuit breaker. An external space of the pressure vessel may be subjected to an atmospheric pressure, and an internal space of the pressure vessel may be filled with an insulating gas having a pressure equal to or higher than atmospheric pressure.

The pressure vessel 10 may have a through-hole 11 formed on one side, such that the spring module 30 may penetrate through and reciprocate in the pressure vessel. A sealing member 12 maintaining internal airtightness of the pressure vessel may be interposed between the through-hole and the spring module.

The vacuum interrupter 20 may be disposed in the pressure vessel 10, and may include a fixed electrode 22 and a movable electrode 23 installed in a vacuum tube 21. The vacuum tube may be composed of a member formed of an insulating material, for example, in a cylindrical shape, but is not necessarily limited thereto. An internal space of the vacuum tube may be in a vacuum state close to 0 bar.

In the vacuum interrupter 20, the fixed electrode 22 may be installed to be fixed in the vacuum tube 21.

In the vacuum interrupter 20, the movable electrode 23 may reciprocate in an axial direction, and one end portion may be in contact with or separated from the fixed electrode 22, and the other end portion may be disposed to protrude in an outward direction through a through-hole 24 of the vacuum tube 21.

The vacuum interrupter 20 may further include a bellows 25 having one side fixed to the vacuum tube 21 and provided to seal a gap between the through-hole 24 of the vacuum tube and the movable electrode 23. The bellows may be contracted and extended in the axial direction, such that a length in the axial direction may be changed.

For example, the bellows 25 may be installed such that one end surrounds the through-hole 24 and the other end surrounds an outer circumferential surface of the movable electrode 23. The bellows may be disposed in this manner, the internal space of the vacuum tube 21 may be maintained in a vacuum state even though the bellows expands and contracts according to an operation of the movable electrode.

Therefore, the bellows 25 may separate a vacuum pressure P_{V} in the vacuum interrupter 20 and a gas pressure P in the pressure vessel 10.

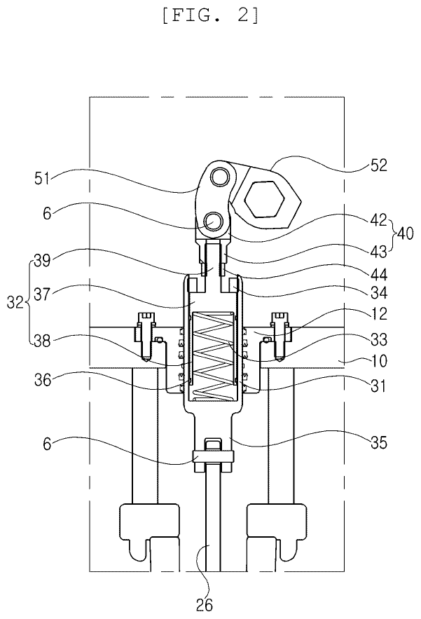

FIG. 2 is an enlarged cross-sectional view illustrating a spring module. As illustrated in FIG. 2, a spring module 30 may include a case 31, a guide 32, a spring 33, and a stopper 34.

The case 31 may be formed as a roughly cylindrical member having one side closed and the other side opened, to safely accommodate and protect the guide 32 and the spring 33 therein.

On the closed one side, an outer surface of the case 31 may be provided with a hinge portion 35 formed to protrude and to be connected to an end portion of a movable electrode 23 via an insulating link 26.

On the opened other side, an inner surface of the case 31 may be equipped with the stopper 34. For example, a female screw thread may be formed on an inner circumferential surface of the case 31, and the stopper 34 may be screwed to the case accommodating the guide 32 and the spring 33, to prevent the guide and the spring from coming off and limit movement of the guide.

The case 31 may reciprocate in an axial direction while maintaining internal airtightness of a pressure vessel 10. To this end, the case may be installed to slide by penetrating an interior of a sealing member 12 installed in a through-hole 11 of the pressure vessel in a low-friction state.

In addition, the case 31 may be connected to the other end portion of the movable electrode 23 by coupling one end of the insulating link 26 and the hinge portion 35 to rotate relative to each other, for example, by a pin 6, such that driving force by a driving unit 5 may be transmitted to the movable electrode.

The insulating link 26 may be formed of an insulating material to electrically insulate the movable electrode 23 and the driving unit 5, and may transmit driving force from the case 31 of the spring module 30 to the movable electrode 23.

The guide 32 may include a plate-shaped support portion 37 having a predetermined thickness in an intermediate portion. On one side of the support portion, a barrier 38 extending from an edge of the support portion may be formed. On the other side of the support portion, a connection portion 39 extending from a central portion of the support portion in the opposite direction of the barrier may be formed.

The barrier 38 may be formed in a plate shape, such as a flat plate or a curved plate, to partition a space therein. The connection portion 39 may be formed to have a rod shape, for example, extended by a predetermined length.

The guide 32, e.g., an edge surface of the support portion 37 and an outer surface of the barrier 38, may reciprocate along the inner circumferential surface of the case 31 in the case 31. In addition, the guide may be restricted from moving by the stopper 34 on the opened other side of the case, as described above.

Optionally, at least one lubricating ring 36 may be interposed between the outer surface of the barrier 38 and the inner circumferential surface of the case 31 for smooth movement of the guide. The lubricating ring may be mounted on the outer surface of the barrier or the inner circumferential surface of the case, and may be formed of an engineering plastic material such as Teflon® or the like, for example.

The spring 33 may be housed in the barrier 38 of the guide 32. For example, the barrier of the guide may at least partially surround the spring.

The barrier 38 of the guide 32 may hold and support the spring such that deformation of the spring 33, e.g., compression or tension, is smoothly linearly performed while reciprocating along the case 31 when driving force is transmitted to the guide, and may provide dynamic stability to restore the spring to an original stable position thereof when a posture of the spring is changed.

In addition, the spring 33 may be disposed between the support portion 37 of the guide 32 and an inner surface of the closed one side of the case 31, and one end may be supported by the inner surface of the closed one side of the case, and the other end may be supported by support portion of the guide. In this manner, the support portion of the guide may act as a kind of spring seat for supporting the spring.

The spring 33 may be formed as, for example, a compression coil spring, but is not necessarily limited thereto, and other spring of any form may be adopted as long as it elastically supports the guide such that the guide 32 moves with a certain displacement in the case 31.

The spring 33 which was under an assembly load in an exposed state may compress the electrodes in the vacuum interrupter 20 with an operating load that compressed and increased by the support portion 37 of the guide 32 and the case 31 when the movable electrode is input, to provide a current-conducting contact pressure between the electrodes. The contact pressure may play roles of offsetting a magnetic field force (blow-off force) separating contacts when a short-circuit current occurs, and preventing resistance welding of the contacts.

The stopper 34 may be composed of a ring-shaped member having a through-hole formed in a central portion and a male screw thread formed on an outer circumferential surface in a lateral direction. As described above, the stopper may be screwed to the inner circumferential surface of the case 31 accommodating the guide 32 and the spring 33, to prevent the guide and the spring from being separated, and limit movement of the guide.

A configuration of the stopper 34 and a connection relationship with the case 31 are not necessarily limited to the above-described examples, and a stopper having any other shape may be adopted as long as it is formed in a ring shape and limits the movement of the guide 32.

The connection portion 39 of the guide 32 may protrude out of the case 31 and the pressure vessel 10 through the through-hole of the stopper 34, and the connection portion may be connected to the driving unit 5 via a driving link 51 and a rotary lever 52 outside the pressure vessel, and may receive driving force from the driving unit.

The rotary lever 52 may be connected to the driving unit 5 directly or by a reducer or the like, to rotate. The driving unit may include, for example, a motor or the like, and may be operated by a control command or a manual operation of a user to generate power, to rotate the rotary lever.

Rotational force of the rotary lever 52 may be transmitted to the driving link 51, and a position of the driving link may be changed according to rotation of the rotary lever, such that the connection portion 39 of the guide 32 may reciprocate in an axial direction of the guide and the case 31.

In this manner, the spring module 30 may be connected to an end portion of the movable electrode 23 on one side via the insulating link 26, and at the same time, may be connected to the driving unit 5 on the other side by penetrating the pressure vessel 10.

Therefore, the spring module 30 may penetrate through and move the sealing member 12 while maintaining airtightness by driving force transmitted from the driving unit 5, to transmit the driving force of the driving unit to the movable electrode 23, and may apply contact pressure to the movable electrode by the spring 33 mounted therein, when the movable electrode is input.

For example, a vacuum circuit breaker according to an embodiment of the present disclosure may be characterized by integrating configurations and functions of the movable rod and the pressure spring connected in series along an axial direction in a vacuum circuit breaker according to the prior art, into a single spring module 30.

Therefore, a vacuum circuit breaker according to an embodiment of the present disclosure may secure stability of an operation and structure of the vacuum circuit breaker by reducing a distance from the pressure vessel 10 to the driving unit 5 and may eliminate a required space to be unnecessarily generated, as compared to the vacuum circuit breaker according to the prior art.

In addition, a rod end fork 40 may be interposed between the connection portion 39 of the guide 32 and the driving link 51. The rod end fork may include a head portion 42 in which a pinhole is formed, and a fastening portion 43 extending to one side of the head portion and at least partially threaded.

One side of the drive link 51 and the head portion 42 of the rod end fork 40 may be connected to each other by, for example, a pin 6 to rotate relative to each other.

As illustrated in FIG. 2, the connection portion 39 of the guide 32 has a male screw thread formed at least partially on the outer circumferential surface thereof, and may be inserted and screwed into the fastening portion 43 of the rod end fork 40. Optionally, a nut 44 preventing releasing may be further fastened to the connection portion.

Configurations and a coupling relationship of the connection portion 39 and the fastening portion 43 are not necessarily limited to the above-described example, and a male screw thread and a female screw thread may be formed opposite each other. For example, a screw groove may be formed in the connection portion, and the male screw thread may be formed at least partially on an outer circumferential surface of the fastening portion, such that the fastening portion may be inserted and screwed into the screw groove of the connection portion.

A coupling length of the connection portion screwed to the fastening portion of the rod end fork may be adjusted, in a state in which the connection portion 39 of the guide 32 and the driving link 51 are connected via the rod end fork 40, to check and adjust stroke of the spring module 30 occurring during operation outside the pressure vessel 10.

As described above, according to an embodiment of the present disclosure, stroke of the spring module may be checked and adjusted outside the pressure vessel, and a distance from the pressure vessel to the driving unit may be reduced, to obtain effects of securing stability of an operation and structure of the vacuum circuit breaker.

In addition, according to an embodiment of the present disclosure, when the driving unit is disposed above the pressure vessel, a mounting height of the driving unit may be lowered to eliminating a required space to be unnecessarily generated.

The above descriptions are may be merely an example of the technical idea of the present disclosure, and those skilled in the art will appreciate that various modifications and variations may be made without departing from the essential characteristics of the present disclosure.

Accordingly, embodiments disclosed in the present disclosure are not intended to limit the technical idea of the present disclosure but to explain it, and the scope of the technical idea of the present disclosure may not be limited by these embodiments. The protection scope of the present disclosure should be interpreted by the following claims, and all technical ideas within the equivalent scope should be interpreted as being included in the scope of the rights of the present disclosure.

### INDUSTRIAL APPLICABILITY

The present disclosure may be useful, for example, for ultra-high voltage gas-insulated switchgears or the like.

1. A vacuum circuit breaker comprising:
a pressure vessel filled with an insulating gas of a predetermined pressure;
a vacuum interrupter disposed in an internal space of the pressure vessel, and having a fixed electrode and a movable electrode in a vacuum tube having a vacuum state; and
a spring module having one side connected to an end portion of the movable electrode via an insulating link, and having a spring applying contact pressure to the movable electrode when the movable electrode is input, wherein the spring module penetrates through and moving in the pressure vessel while maintaining airtightness to transmit driving force of a driving unit to the movable electrode.

2. The vacuum circuit breaker of claim 1, wherein the spring module includes:
a case having one side closed and the other side opened;
a guide receiving the driving force of the driving unit to reciprocate along an inner circumferential surface of the case in an internal space of the case;
the spring having one end supported by an inner surface of the closed one side of the case and the other end supported by the guide; and
a stopper mounted on the opened other side of the case to restrict movement of the guide.

3. The vacuum circuit breaker of claim 2, wherein the case is installed to be slidable while maintaining airtightness in an internal space of a sealing member installed in a through-hole of the pressure vessel, and
a hinge portion protruded and formed to be coupled to rotate relative to the insulating link is provided on an outer surface of the closed one side of the case.

4. The vacuum circuit breaker of claim 2, wherein the guide includes:
a plate-shaped support portion having a predetermined thickness;
a barrier extending from an edge of one side of the support portion; and
a connection portion extending from a central portion of the other side of the support portion, in a direction opposite to a direction facing the barrier.

5. The vacuum circuit breaker of claim 4, wherein the spring is housed in the barrier and has the other end supported by the support portion, and
the connection portion protrudes out of the pressure vessel through a through-hole formed in the stopper, and is connected to the driving unit via a driving link.

6. The vacuum circuit breaker of claim 5, wherein a rod end fork is interposed between the connection portion and the driving link,
the connection portion is screwed to a fastening portion of the rod end fork, and
one side of the driving link and a head portion of the rod end fork are relatively rotatably coupled.

7. The vacuum circuit breaker of claim 4, wherein at least one lubricating ring is interposed between an outer surface of the barrier and the inner circumferential surface of the case for movement of the guide.
